(19) United States
(12) Patent Application Publication
(10) Pub. No.: US 2013/0021298 A1
(43) Pub. Date: Jan. 24, 2013

(54) DISPLAY DEVICE AND DRIVING METHOD THEREOF

(71) Applicants: Seung Mi SEO, Hwaseong-si (KR); Suk Won JUNG, Goyang-si (KR); Sung Hoon YANG, Seoul (KR)

(72) Inventors: Seung Mi SEO, Hwaseong-si (KR); Suk Won JUNG, Goyang-si (KR); Sung Hoon YANG, Seoul (KR)

(73) Assignee: SAMSUNG ELECTRONICS CO., LTD., Suwon-si (KR)

(21) Appl. No.: 13/362,345

(22) Filed: Jan. 31, 2012

(30) Foreign Application Priority Data
Jul. 21, 2011 (KR) 10-2011-0072541

(51) Int. Cl. G06F 3/042

(52) U.S. Cl. 345/175

(57) ABSTRACT

A display device includes: a display panel; and a sensing signal processor connected to the display panel, in which the display panel includes: a gate line which transmits a gate signal; a sensing signal line crossing the gate line; a reference sensing signal line crossing the gate line; a sensing unit connected to the gate line and the sensing signal line, where the sensing unit senses light by a touch on the display panel; and a reference sensing unit connected to the gate line and the reference sensing signal line and blocked from the light by the touch, and where the sensing signal processor is connected to the sensing unit and the reference sensing unit and includes a comparator.

This application claims priority to Korean Patent Application No. 10-2011-0072541, filed on Jul. 21, 2011, and all the benefits accruing therefrom under 35 U.S.C. §119, the content of which in its entirety is herein incorporated by reference.

### BACKGROUND OF THE INVENTION

(a) Field of the Invention Exemplary embodiments of the invention relate to a display device and a driving method thereof, and more particularly, to a display device with a light sensing function and a driving method thereof.

(b) Description of the Related Art

A liquid crystal display typically includes two display panels respectively provided with a pixel electrode and an opposing electrode and a liquid crystal layer interposed therebetween and having dielectric anisotropy. The pixel electrodes may be arranged in a matrix pattern and connected to a switching element such as a thin film transistor to sequentially receive a data voltage on a row by row basis. The opposing electrode may be provided on an entire surface of the display panel and receives a common voltage. The pixel electrode, the opposing electrode and the liquid crystal layer therebetween collectively define a liquid crystal capacitor in view of a circuit, and the pixel electrode and signal lines that transmit the common voltage overlap each other to form a storage capacitor to maintain the voltage applied to the pixel electrode. Similarly as in other types of display devices, the common voltage may be transmitted to a display panel.

A touch screen panel that senses a contact thereon is generally used by being attached to the display device. However, in the touch screen panel, yield reduction and luminance deterioration of the display panel may occur due to increased cost and additional bonding processes. Therefore, a technology for incorporating a sensing element constituted by a thin film transistor or a capacitor in a display area where an image of a display device is displayed has been developed. The incorporated sensing element outputs a sensing signal according to external contact and detects contact information using the sensing signal. A light sensing element among the sensing elements generates a sensing signal using photocurrent generated from incident light and may obtain contact information using the sensing signal.

However, since the sensing element is provided on a display panel together with a display element for a display operation, an incorrect sensing signal may be generated, and an error in a contact sensing operation may be thereby generated.

### BRIEF SUMMARY OF THE INVENTION

Exemplary embodiments of the invention provide a display device with a light sensing function in which an erroneous operation of a light sensing element provided inside thereof is effectively prevented.

An exemplary embodiment of the invention provides a display device including: a display panel; and a sensing signal processor connected to the display panel, in which the display panel includes: a gate line which transmits a gate signal; a sensing signal line crossing the gate line; a reference sensing signal line crossing the gate line; a sensing unit connected to the gate line and the sensing signal line, where the sensing unit senses light by a touch on the display panel; and a reference sensing unit connected to the gate line and the reference sensing signal line and blocked from the light by the touch, and where the sensing signal processor is connected to the sensing unit and the reference sensing unit and includes a comparator.

In an exemplary embodiment, the sensing signal processor may further include: a first integrator which processes a sensing signal transmitted from the sensing unit to the sensing signal line to generate a sensing output signal; and a second integrator which processes a reference sensing signal transmitted from the reference sensing unit to the reference sensing signal line to generate a reference sensing output signal.

In an exemplary embodiment, the comparator may include a first input terminal connected to the first integrator and a second input terminal connected to the second integrator, and the comparator may receive and compare the sensing output signal and the reference sensing output signal and generate an output value.

In an exemplary embodiment, the display device may further include a contact determining unit which determines that no touch is present when the output value is about zero (0).

In an exemplary embodiment, the sensing unit may include a sensing switching element connected to the gate line and the sensing signal line, a sensing element connected to the sensing switching element and a sensing capacitor connected to the sensing switching element, and the reference sensing unit may include a reference sensing switching element connected to the gate line and the reference sensing signal line, a reference sensing element connected to the reference sensing switching element and a reference sensing capacitor connected to the reference sensing switching element.

In an exemplary embodiment, the display device may further include: a sensing control voltage line connected to a control terminal of the sensing element and a control terminal of the reference sensing element; and a common voltage line connected to the sensing capacitor and the reference capacitor and which transmits a common voltage.

In an exemplary embodiment, the display panel may further include: an image data line crossing the gate line and which transmits an image data voltage; and a pixel connected to the gate line and the image data line.

In an exemplary embodiment, the display panel may further include a lower panel, an upper panel disposed opposite to the lower panel and a liquid crystal layer interposed between the lower panel and the upper panel, and the gate line, the common voltage line, the sensing unit and the reference sensing unit may be disposed on the lower panel.

In an exemplary embodiment, the pixel may include a pixel switching element connected to the gate line and the image data line, a liquid crystal capacitor connected to the pixel switching element and a storage capacitor, and the liquid crystal capacitor may include a pixel electrode which receives the image data voltage and an opposing electrode which receives the common voltage.

In an exemplary embodiment, the display panel may include a display area where a plurality of pixels are disposed and a peripheral area surrounding at least a portion of the display area, and the reference sensing unit and the reference sensing signal line may be disposed in the peripheral area.

Another exemplary embodiment of the invention provides a driving method of a display device including a gate line, a sensing signal line and a reference sensing signal line that cross the gate line, a sensing unit connected to the gate line and the sensing signal line, and a reference sensing unit connected to the gate line and the reference sensing signal line, the method including: applying a gate-on voltage to the gate line; applying a reference voltage to the sensing unit and the reference sensing unit; applying a gate-off voltage to the gate line; transmitting a sensing signal from the sensing unit to the sensing signal line and transmitting a reference sensing signal from the reference sensing unit to the reference sensing signal line; generating a sensing output signal by processing the sensing signal and generating a reference sensing output signal by processing the reference sensing signal; and comparing the sensing output signal with the reference sensing output signal.

In an exemplary embodiment, the sensing unit may sense light by a touch on the display device and the reference sensing unit may be blocked from the light by the touch.

In an exemplary embodiment, the generating the sensing output signal by processing the sensing signal and the generating the reference sensing output signal by processing the reference sensing signal may include temporally integrating the sensing signal and temporally integrating the reference sensing signal.

In an exemplary embodiment, the driving method may further include generating an output value after the comparing the sensing output signal with the reference sensing output signal.

In an exemplary embodiment, the driving method may further include determining that no touch is present when the output value is about zero (0).

In an exemplary embodiment, the sensing unit may include: a sensing switching element connected to the gate line and the sensing signal line; a sensing element; and a sensing capacitor connected to the sensing switching element, and the reference sensing unit may include: a reference sensing switching element connected to the gate line and the reference sensing signal line; a reference sensing element connected to the reference sensing switching element; and a reference sensing capacitor connected to the reference sensing switching element.

In an exemplary embodiment, the applying the reference voltage to the sensing unit and the reference sensing unit may include applying the reference voltage to the sensing capacitor of the sensing unit and the reference sensing capacitor of the reference sensing unit.

In an exemplary embodiment, the sensing signal line and the reference sensing signal line may transmit the reference voltage.

According to exemplary embodiments of the invention, an error of contact information is effectively prevented from occurring by further including a reference sensing unit disposed in an area where light is not irradiated and not influenced by a touch in addition to a sensing unit which senses irradiation of light and generates a sensing signal and by comparing sensing signals from the sensing unit and the reference sensing unit.

### BRIEF DESCRIPTION OF THE DRAWINGS

The above and other features of the invention will become more apparent by describing in detailed exemplary embodiments thereof with reference to the accompanying drawings, in which:

FIG. 1 is a block diagram showing an exemplary embodiment of a display device according to the invention;

FIGS. 2 to 4 are block diagrams showing alternative exemplary embodiments of a display device according to the invention;

FIGS. 5 and 6 are block diagrams showing exemplary embodiments of a display device according to the invention.

FIG. 7 is a circuit diagram showing an exemplary embodiment of a display device according to the invention; and

FIGS. 8 and 9 are schematic equivalent circuit diagrams showing exemplary embodiments of a display device according to the invention.

### DETAILED DESCRIPTION OF THE INVENTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein. Hereinafter, the invention will be explained in detail with reference to the accompanying drawings.

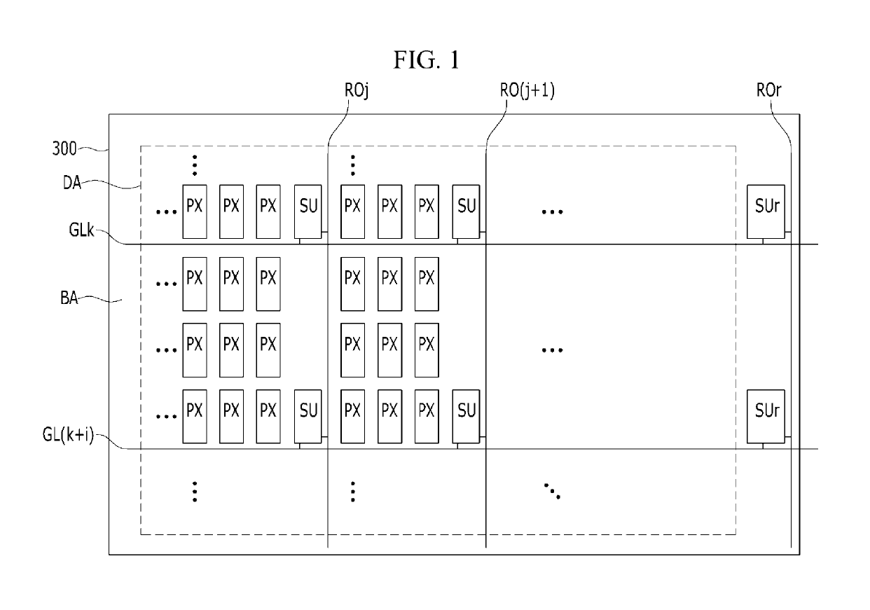

Referring to FIG. 1, an exemplary embodiment of a display device according to the invention will be described.

FIG. 1 is a block diagram showing an exemplary embodiment of a display device according to the invention.

Referring to FIG. 1, an exemplary embodiment of a display device according to the invention has a light sensing function and includes a display panel 300 including a display area DA and a peripheral area BA.

In an exemplary embodiment, a plurality of signal lines, a plurality of pixels PX arranged substantially in a matrix pattern, and a plurality of sensing units SU are disposed on the display area DA of the display panel 300.

The signal lines include a plurality of gate lines GLn (n=1, 2, . . . ) that transmits scanning signals (or gate signals), a plurality of image data lines (not shown) that transmits image data signals, and a plurality of sensing signal lines ROm (m=1, 2, . . . ).

The gate lines GLn may extend substantially in a row direction and are substantially parallel to each other, and the image data lines and the sensing signal lines ROm may extend substantially in a column direction. The sensing signal lines ROm may constantly receive a reference voltage Vf and transmit sensing signals from the sensing units SU.

Each of the pixels PX may include a switching element, connected to a corresponding gate line GLn and a corresponding image data line, and a pixel electrode (not shown) connected thereto. Each of the pixels PX may display one of primary colors such as three primary colors of red, green and blue to display a color image. Three pixels PX that display the three primary colors, respectively, may collectively define a unit dot.

The sensing unit SU senses light and thereby generates a sensing signal. The sensing unit SU may be disposed between two adjacent pixels PX in a row direction. One sensing unit SU may be disposed every three pixels PX in a row direction, and one sensing unit SU may be disposed every three pixels PX in a column direction. In such an embodiment, the density of the sensing units SU in the row direction or the column direction may be, for example, about ⅓ of the density of the pixels.

The sensing unit SU may include a sensing switching element connected to the gate lines GLn and the sensing signal lines ROm. The sensing switching elements of two adjacent sensing units SU in a column direction may be connected to a k-th gate line GLk (k=1, 2, . . . ) and a (k+i)-th gate line GL(k+i)) (i is an integer greater than or equal to 1), respectively. The sensing switching elements of two adjacent sensing units SU in a row direction may be connected to two adjacent sensing signal lines, e.g., a j-th sensing signal line ROj and a (j+1)-th sensing signal line RO (j+1) (j=1, 2, . . . , m−1), respectively.

The peripheral area BA of the display panel 300 is a region surrounding the display area DA, and on which an image is not displayed, and may be completely blocked from light.

In an exemplary embodiment, the gate lines GLn of the display area DA extend on the peripheral area BA, and a reference sensing signal line ROr and a plurality of reference sensing units SUr are provided on the peripheral area BA.

The gate lines GLn may extend to the peripheral area BA of the display panel 300. In one exemplary embodiment, for example, only the gate lines GLk and GL(k+i) (k=1, 2, . . . ) connected to the sensing units SU in the display area DA extend to the peripheral area BA.

The reference sensing signal lines ROr may extend substantially parallel to the sensing signal lines ROj and RO(j+1) in the display area DA in a column direction. The reference sensing signal line ROr may constantly receive the reference voltage Vf. The reference sensing signal line ROr may transmit a reference sensing signal from the reference sensing units SUr.

Each of the reference sensing units SUr may include a reference sensing switching element connected to the gate lines GLn and the reference sensing signal lines ROj and RO(j+1). In such an embodiment, the gate lines GLn connected with the reference sensing switching element of the reference sensing unit SUr may be limited to the gate lines to which the sensing units SU are connected in the display area. In an exemplary embodiment, the gate lines GLk and GL(k+i) connected with the sensing units SU in the display area DA may be connected to the reference sensing unit SUr in the peripheral area BA.

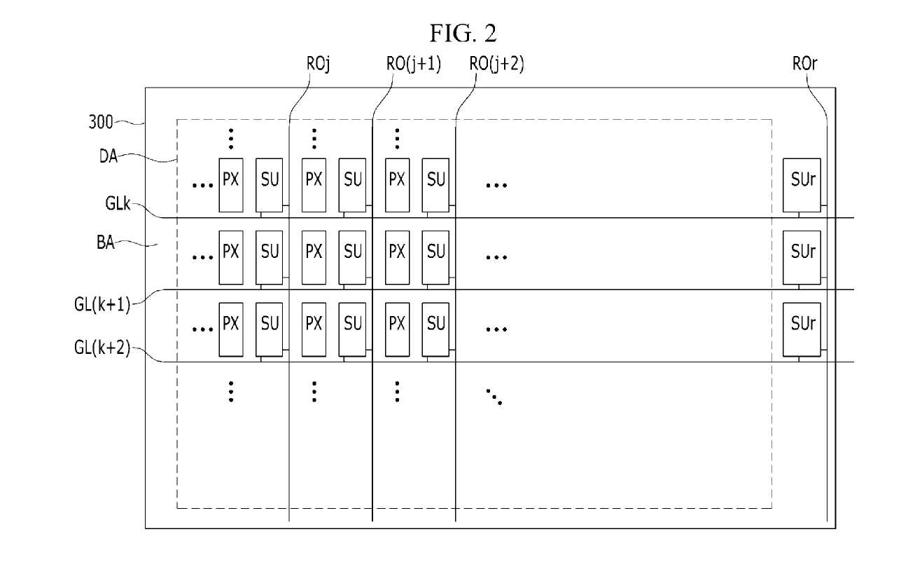

Hereinafter, alternative exemplary embodiments of a display device according to the invention will be described with reference to FIGS. 2 to 4. The same or like elements shown in FIGS. 2 to 4 have been labeled with the same reference characters as used above to describe the exemplary embodiments of the display device shown in FIG. 1, and any repetitive detailed description thereof will hereinafter be omitted or simplified.

FIGS. 2 to 4 are block diagrams showing alternative exemplary embodiments of a display device according to the invention.

Referring to FIG. 2, an alternative exemplary embodiment of the display device is substantially the same as the exemplary embodiment of the display device shown in FIG. 1, except for densities of sensing units SU in display areas DA. In the illustrated embodiment, for example, one sensing unit SU may be disposed every pixel PX in a row direction and one sensing unit SU may be disposed every pixel PX in a column direction. In such an embodiment, the density of the sensing units SU in the row direction or the column direction may be substantially the same as the density of the pixels PX.

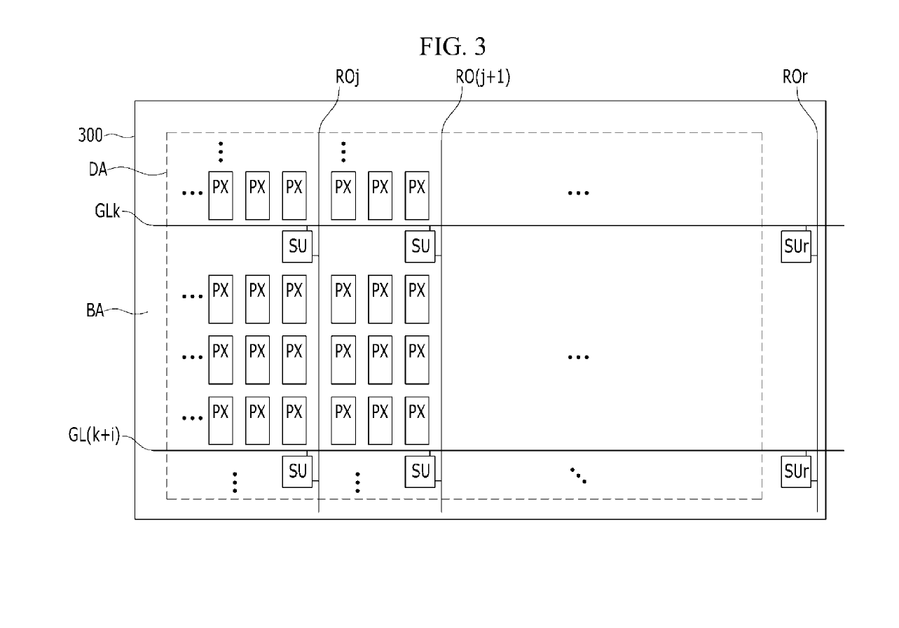

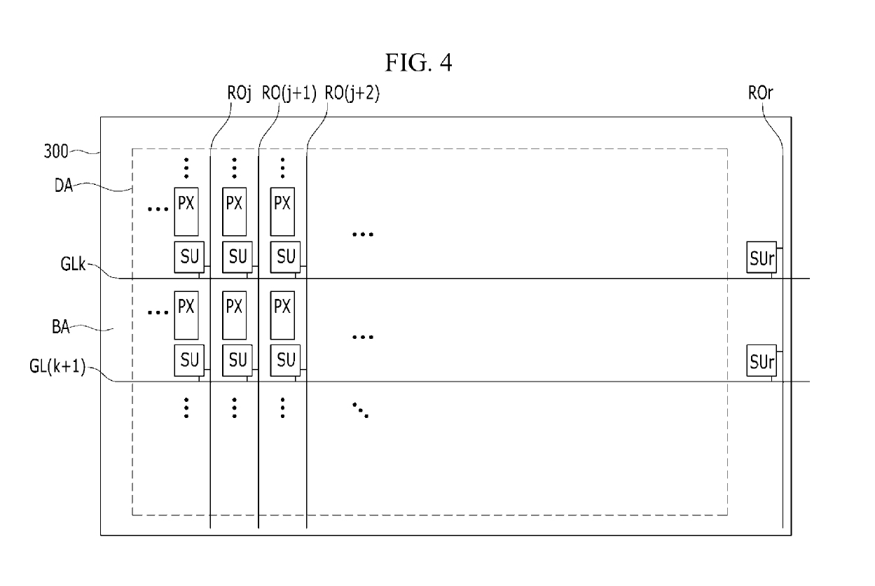

Referring to FIG. 3, another alternative exemplary embodiment of the display device is substantially the same as the exemplary embodiment of the display device shown in FIG. 1, except that the sensing units SU in the display area DA may be positioned between adjacent pixels PX in the column direction. The density of the sensing units SU may be equal to or less than the density of the pixels PX. FIG. 4 shows an exemplary embodiment of the display device in which the density of the sensing units SU is the same as the density of the pixels PX.

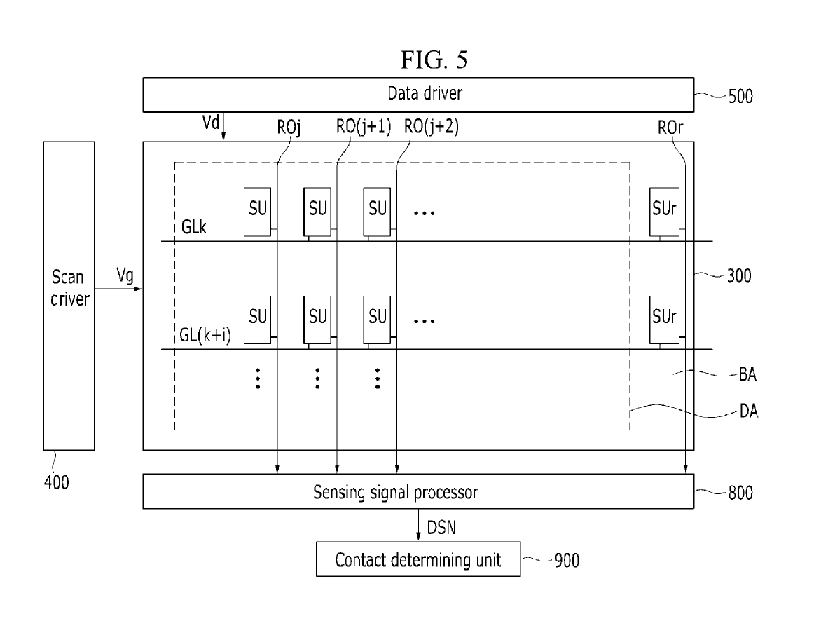

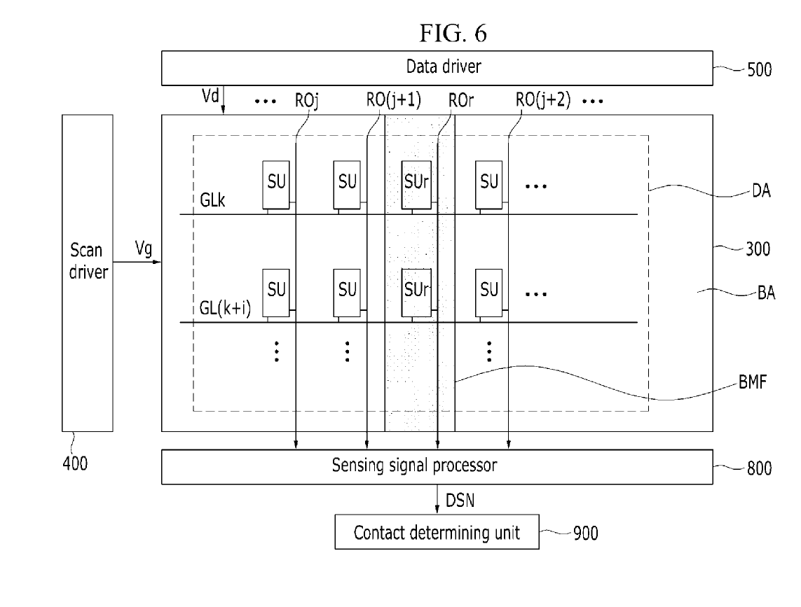

Hereinafter, an alternative exemplary embodiment of a display device according to the invention will be described with reference to FIGS. 5 and 6. The same or like elements shown in FIGS. 5 and 6 have been labeled with the same reference characters as used above to describe the exemplary embodiments of the display device shown in FIG. 1, and any repetitive detailed description thereof will hereinafter be omitted or simplified.

FIGS. 5 and 6 are block diagrams showing exemplary embodiments of a display device according to the invention.

Referring to FIG. 5, an exemplary embodiment of a display device includes a display panel 300, a scan driver 400, a data driver 500, a sensing signal processor 800 and a contact determining unit 900.

The display panel 300 is substantially the same as the exemplary embodiment shown in FIGS. 1 to 4 described above, and any repetitive detailed description thereof will be omitted.

In an exemplary embodiment, the scan driver 400 is connected to the gate lines GLk and GL(k+i) (k=1, 2, . . . ) (i is an integer greater than or equal to 1) of the display panel 300. The scan driver 400 applies a gate signal Vg including a gate-on voltage and a gate-off voltage to the gate lines GLk and GL(k+i). In such an embodiment, the gate-on voltage turns on the switching elements of a pixel PX, a sensing unit SU and a reference sensing unit Sur, and the gate-off voltage turns off the switching elements of the pixel PX, the sensing unit SU and the reference sensing unit Sur.

The data driver 500 is connected to the image data lines (not shown) of the display panel 300 and applies image data voltages Vd to the image data lines.

The sensing signal processor 800 is connected to the sensing signal lines ROj, RO(j+1) and RO(j+2) and a reference sensing signal line ROr of the display panel 300. The sensing signal processor 800 receives and processes sensing signals from the sensing signal lines ROj, RO(j+1), and RO(j+2) and a reference sensing signal from the reference sensing signal line ROr. The sensing signal processor 800 compares the processed sensing signals with the processed reference sensing signal, and generates a digital sensing signal DSN using an analog-to-digital conversion.

After the contact determining unit 900 receives and processes the digital sensing signal DSN from the sensing signal processor 800 and determines whether a contact occurs or not, and a position of the contact, the contact determining unit 900 may generate contact information.

Referring to FIG. 6, an alternative exemplary embodiment of a display device according to the invention is substantially the same as the exemplary embodiment of the display device shown in FIG. 5, except that a reference sensing unit SUr and a reference sensing signal line ROr may be positioned in a display area DA instead of a peripheral area BA of a display panel 300. The reference sensing signal line ROr may be positioned between two adjacent sensing signal lines RO(j+1) and RO(j+2) (j=0, 1, . . . , (m−2)). The reference sensing unit SUr may be connected to the gate lines GLk and GL(k+i) (k=1, 2, . . . ) (i is an integer greater than or equal to 1) connected with sensing units SU and the reference sensing signal line ROr.

In an exemplary embodiment, as shown in FIG. 6, the reference sensing unit SUr may be covered by a light blocking filter member that blocks light (e.g., visible rays, infrared rays and ultraviolet rays) sensed by the sensing units SU. In such an embodiment, when the sensing units SU sense light in a specific wavelength range (e.g., visible rays and infrared rays), the light blocking filter member may substantially completely block the light in the specific wavelength range.

The reference sensing unit SUr may be disposed at different positions where light is not irradiated without limiting to the reference sensing unit SUr shown in FIG. 6.

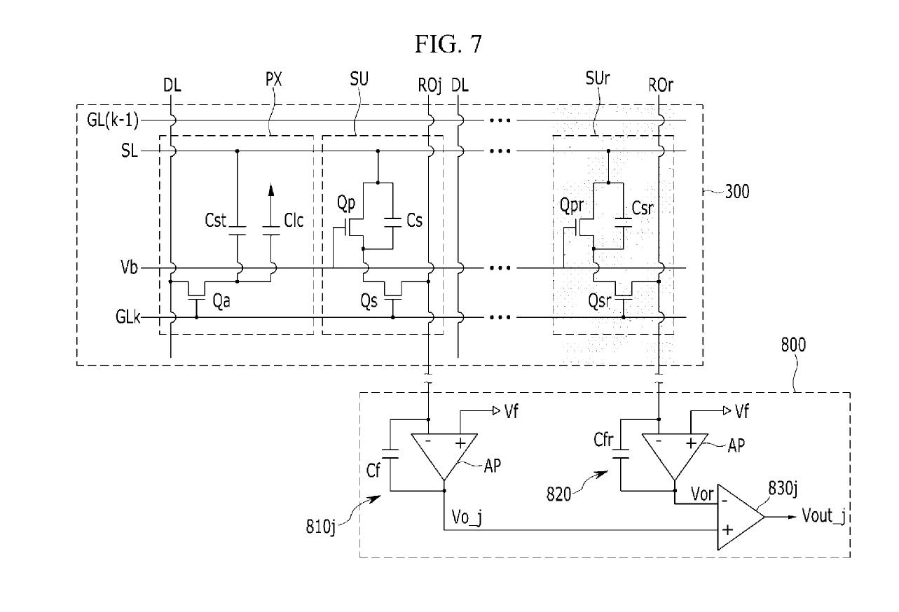

Hereinafter, a structure of exemplary embodiments of the display panel 300 of the display device and the sensing signal processor 800 will be described in detail with reference to FIGS. 7 to 9. Like constituent elements as those of the exemplary embodiment described above are designated with like reference numerals and a duplicated description is omitted.

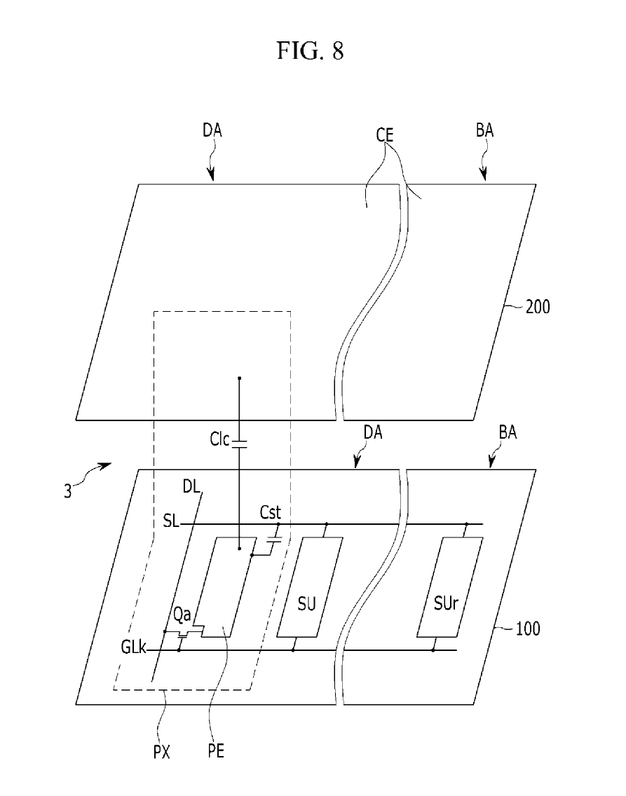

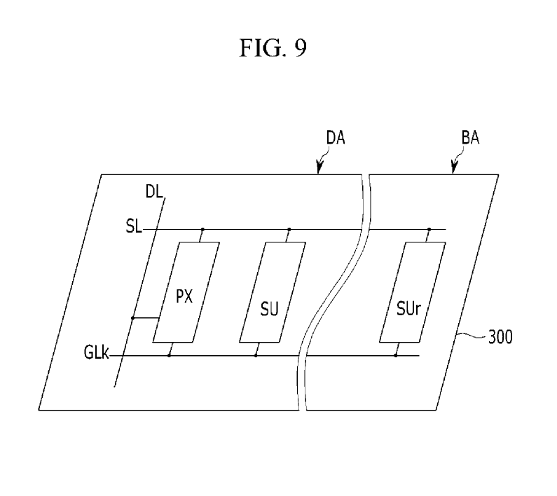

FIG. 7 is a circuit diagram showing an exemplary embodiment of a display device according to an exemplary embodiment of the invention, and FIGS. 8 and 9 are schematic equivalent circuit diagrams showing exemplary embodiments of a display device according to the invention.

A display panel 300 of an exemplary embodiment of a display device includes a plurality of signal lines GL(k−1), GLk, DL, SL and Vb, a plurality of pixels PX, a plurality of sensing units SU and a reference sensing unit SUr. In an exemplary embodiment, the display device may be a liquid crystal display, but not being limited thereto. Referring to FIG. 8, a display panel 300 of the liquid crystal display includes a lower panel 100 and an upper panel 200 opposite to each other, and a liquid crystal layer 3 interposed therebetween.

The signal lines GL(k−1), GLk, DL, SL and Vb include a plurality of gate lines GL(k−1) and GLk that transmits gate signals, a plurality of image data lines DL that transmits image data signals, a common voltage line SL, a plurality of sensing signal lines ROj that transmits sensing signals, a reference sensing signal line ROr that transmits a reference sensing signal and a sensing control voltage line Vb.

The gate lines GL(k−1) and GLk may extend substantially in a row direction, and each of the image data lines DL, the sensing signal lines ROj and the reference sensing signal line ROr may extend substantially in a column direction. The gate lines GL(k−1) and GLk, the image data lines DL, the sensing signal lines ROj and the reference sensing signal line ROr are substantially the same as those described in the exemplary embodiments shown in FIGS. 1 to 5, and any repetitive detailed description thereof will hereinafter be omitted.

The common voltage line SL may transmit a common voltage, and extend substantially in a substantially row direction.

The sensing control voltage line Vb may transmit a voltage that is substantially low or high, e.g., the gate-off voltage, and may extend substantially in a row direction.

The pixel PX includes a pixel switching element Qa connected to a corresponding gate line, e.g., a k-th gate line GLk, and the image data line DL, a liquid crystal capacitor Clc connected to the pixel switching element Qa and a storage capacitor Cst.

The pixel switching element Qa may be a three terminal element, e.g., a thin film transistor, provided on the lower panel 100. In an exemplary embodiment, a control terminal of the pixel switching element Qa is connected to the corresponding gate line GLk, an input terminal of the pixel switching element Qa is connected to the image data line DL, and an output terminal of the pixel switching element Qa is connected to the liquid crystal capacitor Clc and the storage capacitor Cst.

The liquid crystal capacitor Clc may be defined by a pixel electrode PE of the lower panel 100 and an opposing electrode CE of the upper panel 200, as two terminals thereof, and the liquid crystal layer 3 interposed between the two electrodes PE and CE serves as a dielectric material thereof. The pixel electrode PE is connected to the pixel switching element Qa and the opposing electrode CE may be provided on the entire surface of the upper panel 200 and receives the common voltage. In an alternative exemplary embodiment, differently from the exemplary embodiment shown in FIG. 8, the opposing electrode CE may be disposed on the lower panel 100.

The storage capacitor Cst maintains the charged voltage of the liquid crystal capacitor Clc. The storage capacitor Cst may be formed by overlapping the common voltage line SL and the pixel electrode PE with an insulator interposed therebetween.

The sensing unit SU includes a sensing switching element Qs, a sensing element Qp and a sensing capacitor Cs. In such an embodiment, the sending switching element Qs is connected to the corresponding gate line GLk and sensing signal line ROj, and the sensing element Qp and the sensing capacitor Cs are connected to the sensing switching element Qs. In an exemplary embodiment, the sensing units SU may be disposed on the lower panel 100 as shown in FIG. 8.

The sensing switching element Qs is a three terminal element, e.g., a thin film transistor. A control terminal of the sensing switching elements Qs is connected to the corresponding gate line GLk, an input terminal of the sensing switching elements Qs is connected to the sensing signal line ROj, and an output terminal of the sensing switching elements Qs is connected to the sensing element Qp. The sensing switching element Qs may transmit a reference voltage Vf of the sensing signal line ROj to the sensing capacitor Cs or transmit a sensing signal to the sensing signal line ROj in response to a gate signal of the corresponding gate line GLk.

The sensing element Qp is a three terminal element, e.g., a thin film transistor. A control terminal of the sensing element Qp is connected to the sensing control voltage line Vb, an input terminal of the sensing element Qp is connected to the sensing switching element Qs, and an output terminal of the sensing element Qp is connected to the common voltage line SL. A sensing control voltage, which is substantially low or high, may be maintained in the sensing control voltage line Vb such that the sensing element Qp may be maintained at an off state when no light is irradiated.

Two terminals of the sensing capacitor Cs are connected to the switching element Qs and the common voltage line SL. The sensing capacitor Cs may be charged with the reference voltage Vf of the sensing signal line ROj in response to a gate signal of the corresponding gate line GLk or discharged in response to a photocurrent of the sensing element Qp.

A structure of the reference sensing unit SUr is substantially the same as the structure of the sensing unit SU, and any repetitive description thereof will hereinafter be omitted.

The reference sensing unit SUr includes a reference sensing switching element Qsr, a reference sensing element Qpr and a reference sensing capacitor Csr. The reference sensing switching element Qsr is connected to the corresponding gate line GLk and the reference sensing signal line ROr, and the reference sensing element Qpr and the reference sensing capacitor Csr are connected to the reference sensing switching element Qsr. In an exemplary embodiment, the reference sensing unit SUr may be integrated on the lower panel as shown in FIG. 8. In an exemplary embodiment, the reference sensing unit SUr may be disposed in the peripheral area BA of the lower panel 100 where light is not irradiated.

The reference sensing switching element Qsr is a three terminal element, e.g., a thin film transistor. A control terminal of the reference sensing switching element Qsr is connected to the corresponding gate line GLk, an input terminal of the reference sensing switching element Qsr is connected to the reference sensing signal line ROr, and an output terminal of the reference sensing switching element Qsr is connected to the reference sensing element Qpr. The reference sensing switching element Qsr may transmit the reference voltage Vf of the reference sensing signal line ROr to the reference sensing capacitor Csr or transmit the reference sensing signal to the reference sensing signal line ROr in response to a gate signal of the corresponding gate line GLk.

The reference sensing element Qpr is a three terminal element, e.g., a thin film transistor. A control terminal of the reference sensing element Qpr is connected to the sensing control voltage line Vb, an input terminal of the reference sensing element Qpr is connected to the reference sensing switching element Qs, and an output terminal of the reference sensing element Qpr is connected to the common voltage line SL.

Two terminals of the reference sensing capacitor Csr are connected to the reference sensing switching element Qsr and the common voltage line SL.

In an exemplary embodiment, the sensing switching element Qs, the sensing element Qp the sensing capacitor Cs of the sensing unit SU, the reference sensing switching element Qsr, the reference sensing element Qpr and the reference sensing capacitor Csr of the reference sensing unit SUr may be integrated on the lower panel 100 together with the pixel switching element Qa of the pixel PX and a plurality of signal lines, e.g., the gate lines GLk, the sensing control voltage line Vb, the common voltage line SL, the sensing signal lines ROj and the image data lines DL.

In an exemplary embodiment, the display device is constituted by one display panel 300 similarly as in the exemplary embodiment shown in FIG. 9, and pixels PX, sensing units SU and a reference sensing unit SUr may be provided on the one display panel 300 together with a plurality of signal lines, e.g., the image data lines DL, the common voltage line SL and the gate lines GLk.

An exemplary embodiment of a sensing signal processor 800 of a display device according to the invention includes a plurality of integrators 810j (j=1, 2, . . . ) connected to the sensing signal lines ROj (j=1, 2, . . . ) of the display panel 300, a reference integrator 820 connected to the reference sensing signal line ROr, and a plurality of comparators 830j (j=1, 2, . . . ).

Each of the integrators, e.g., a j-th integer 810j, includes an amplifier AP having an inversion terminal (−), a non-inversion terminal (+) and an output terminal, and a capacitor Cf connected thereto. The inversion terminal (−) of the amplifier AP of the j-th integrator 810j is connected to the sensing signal line ROj, and the capacitor Cf is connected between the inversion terminal (−) and the output terminal. The non-inversion terminal (+) of the amplifier AP of the j-th integrator 810j is connected to the reference voltage Vf. The amplifier AP and the capacitor Cf, as an integrator, e.g., a current integrator, integrate the current of the sensing signal from the sensing signal line ROj for a predetermined time and generate a sensing output signal Vo_j.

The reference integrator 820 includes an amplifier AP having an inversion terminal (−), a non-inversion terminal (+) and an output terminal, and a capacitor Cfr connected thereto. The inversion terminal (−) of the amplifier AP of the reference integrator 820 is connected to the reference sensing signal line ROr, and the capacitor Cfr is connected between the inversion terminal (−) and the output terminal. The non-inversion terminal (+) of the amplifier AP of the reference integrator 820 is connected to the reference voltage Vf. The amplifier AP and the capacitor Cfr, as an integrator, e.g., a current integrator, integrate the current of the reference sensing signal from the reference sensing signal line ROr for a predetermined time and generate a reference sensing output signal Vor.

The comparators 830j (j=1, 2, . . . ) may include amplifiers. The non-inversion terminal (+) of the comparator 830j is connected to an output terminal of the integrator 810j to receive the sensing output signal Vo_j, and the inversion terminal (−) of the comparator 830j is connected to an output terminal of the reference integrator 820 to receive the reference sensing output signal Vor. The comparator 830j compares the sensing output signal Vo_j of the j-th integrator 810j with the reference sensing output signal Vor to generate an output value Vout_j. When the sensing output signal Vo_j is substantially equal to the reference sensing output signal Vor, the output value Vout_j is about zero (0), and when the sensing output signal Vo_j is not equal to the reference sensing output signal Vor, the output value Vout_j may be a value greater or less than zero (0).

Hereinafter, a display operation and a sensing operation of an exemplary embodiment of the display device will be described in detail with reference to FIGS. 5 to 8.

The data driver 500 applies the image data voltage generated based on the external input image signal to the image data line DL.

The scan driver 400 applies the gate-on voltage to the gate lines GLk (k=1, 2, . . . ) in sequence to turn on the pixel switching element Qa, the sensing switching element Qs and the reference sensing switching element Qsr, which are connected to the gate lines GLk. Thereafter, the image data voltage applied to the image data lines DL is transmitted to the corresponding pixel PX through the turned-on pixel switching element Qa, and the reference voltage Vf is applied to the corresponding sensing unit SU and the reference sensing unit SUr through the turned-on sensing switching element Qs and the turned-on reference sensing switching element Qsr.

A difference between the image data voltage applied to the pixel PX and the common voltage becomes a charged voltage of the liquid crystal capacitor Clc, i.e., a pixel voltage. Orientations of liquid crystal molecules vary depending on the magnitude of the pixel voltage, and as a result, polarization of light passing through the liquid crystal layer 3 varies. The variation of the polarization is represented as variation in transmittance of light by the polarizer, and a desired image is thereby displayed.

The reference voltage Vf applied to the sensing unit SU is transmitted to one terminal of the sensing capacitor Cs, such that the sensing capacitor Cs may be charged by a difference between the reference voltage Vf and the common voltage. Similarly, the reference voltage Vf applied to the reference sensing unit SUr is transmitted to one terminal of the reference sensing capacitor Csr, such that the reference sensing capacitor Cs may be charged with a voltage of a difference between the reference voltage Vf and the common voltage.

When the gate-off voltage is applied to the gate line GLk, the pixel switching element Qa, the sensing switching element Qs and the reference sensing switching element Qsr are turned off.

In such an embodiment, the liquid crystal capacitor Clc and the storage capacitor Cst of the pixel PX continuously maintain the charged pixel voltage.

While the sensing switching element Qs and the reference sensing switching element Qsr are turned off, when light is irradiated to the sensing element Qp of the sensing unit SU by a touch, photocurrent is generated in the sensing element Qp. Thereafter, a voltage drop is generated at a terminal of the sensing capacitor Cs to which the reference voltage Vf is applied, and the sensing capacitor Cs is discharged. However, since the reference sensing unit SUr is disposed in the peripheral area BA of the display panel 300 where the light is not irradiated or covered with the light blocking filter member that blocks the light, leakage current is not generated in the reference sensing element Qpr and the charged voltage of the reference sensing capacitor Csr may be continuously maintained.

In such an embodiment, when the light is not irradiated to the sensing element Qp in the absence of the touch, the sensing capacitor Cs of the sensing unit SU is not discharged.

By repetitively performing the processes by the unit of one horizontal period (also referred to as “1H” and the same as one period of a horizontal synchronization signal and a data enable signal), the gate-on voltage is applied to all of the gate lines GLk in sequence, such that all of the pixels PX display an image of a unit frame, and the sensing unit SU may vary in the voltage of the sensing capacitor Cs based on the presence or absence of a touch.

A state of an inversion signal applied to the data driver 500 may be controlled such that one frame ends, and then next frame starts, and the polarity of the common voltage of the image data voltage (hereinafter, referred to as “polarity of the image data voltage”) applied to each pixel PX is opposite to the polarity of the previous frame (“frame inversion”). In such an embodiment, the polarity of the image data voltage flowing through one of the image data lines DL is changed according to the characteristic of the inversion signal even in one frame or the polarities of the image data voltage applied to one pixel PX row may be different from each other. In such an embodiment, the polarity of the pixel voltage applied to the plurality of pixels PX in the display area DA may change using 1×1 dot inversion, 2×1 dot inversion, row inversion and column inversion, for example, based on the connection relationship between the pixels and the gate lines GLk and the image data lines DL.

When the gate-on voltage is applied to the gate line GLk in the next frame, the pixel switching element Qa, the sensing switching element Qs and the reference sensing switching element Qsr connected to the gate line GLK are turned on. Thereafter, the pixel PX operates similarly as in the previous frame. However, when the charged voltage of the sensing capacitor Cs is changed by the presence of the touch in the previous frame, the reference voltage Vf is recharged to the sensing capacitor Cs through the turned-on sensing switching element Qs. During the recharging, a current occurs in the sensing signal line ROj to generate the sensing signal and the generated sensing signal is integrated in the integrator 810j of the sensing signal processor 800.

In such an embodiment, even when the touch is absent in the previous frame, the charged voltage of the sensing capacitor Cs is changed, and as a result, a current may be generated in the sensing signal line ROj in the next frame. In an exemplary embodiment, the sensing unit SU is integrated on the lower panel 100 together with the pixel switching element Qa of the pixel PX and other signal lines, the charged voltage of the sensing capacitor Cs may be changed through coupling with several driving signals such as the image data voltage during a display operation of the display device when there is no touch. In one exemplary embodiment, for example, where the polarity of the image data voltage applied to the pixel electrode PE corresponding to the displayed image is inclined to one polarity (e.g., + or −), the common voltage of the opposing electrode CE of the upper panel 200 facing the pixel electrode PE or the common voltage line SL of the lower panel 100 may be fluctuated by a capacitive coupling with the pixel electrode PE. In such an embodiment, the charged voltage value of the sensing capacitor Cs of the sensing unit SU connected to the common voltage line SL may be changed in absence of the touch. In such an embodiment, when the gate on voltage is applied to the gate line GLk in the next frame in absence of the touch, a current may flow in the sensing signal line ROj and a sensing signal may be thereby generated, and thus, the touch may be recognized through the processing in the sensing signal processor 800 and an error of contact information may be generated. Accordingly, it may be determined that a touch is present in absence of a touch.

In the exemplary embodiment of the invention, the reference sensing unit Sur, which is not influenced by the touch and having a structure substantially the same as the structure of the sensing unit SU, is provided, such that an error of the contact information due to erroneously generated sensing signal may be effectively prevented from being generated.

When no touch is present, even though the common voltage of the common voltage line SL is fluctuated, the charged voltage of the reference sensing capacitor Csr of the reference sensing unit SUr is substantially the same as the charged voltage of the sensing capacitor Cs at all times. Therefore, the sensing signal of the sensing signal line ROj and the reference sensing signal of the reference sensing signal line ROr may also be substantially the same as each other. Accordingly, the output value Vout_j of the comparator 830j of the sensing signal processor 800 is about zero (0), and the contact determining unit 900 thereby determines that no touch is present.

In an exemplary embodiment, when there is a touch, the reference sensing unit SUr is not irradiated with the light by the touch, such that the reference sensing unit SUr operates differently from the sensing unit SU. Therefore, the sensing signal of the sensing signal line ROj and the reference sensing signal of the reference sensing signal line ROr are not the same as each other. Accordingly, the comparator 830j of the sensing signal processor 800 outputs the output value Vout_j not substantially equal to zero (0). In such an embodiment, the contact determining unit 900 may determine that at least one touch is present, and generate contact information such as a touch position based on a digital sensing signal DSN from the sensing signal processor 800.

In an exemplary embodiment, the reference sensing unit SUr is influenced by various factors (e.g., a variation in the common voltage of the common voltage line SL and a variation in the image data voltage of the image data line DL) other than the irradiation of the light based on the touch on the display panel 300 similarly as the sensing unit SU. Accordingly, the error of the contact information due to the influence factors other than the touch may be effectively prevented by comparing the sensing signal from the sensing unit SU with the reference sensing signal from the reference sensing unit SUr in the comparator 830j and using the output value that is a comparison value.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display device, comprising:
a display panel; and
a sensing signal processor connected to the display panel,
wherein the display panel comprises:
a gate line which transmits a gate signal;
a sensing signal line crossing the gate line;
a reference sensing signal line crossing the gate line
a sensing unit connected to the gate line and the sensing signal line, wherein the sensing unit senses light by a touch on the display panel; and
a reference sensing unit connected to the gate line and the reference sensing signal line, wherein the reference sensing unit is blocked from the light by the touch, and
wherein the sensing signal processor is connected to the sensing unit and the reference sensing unit, and comprises a comparator.

2. The display device of claim 1, wherein the sensing signal processor further comprises:
a first integrator which processes a sensing signal transmitted from the sensing unit to the sensing signal line to generate a sensing output signal; and
a second integrator which processes a reference sensing signal transmitted from the reference sensing unit to the reference sensing signal line to generate a reference sensing output signal.

3. The display device of claim 2, wherein
the comparator includes a first input terminal connected to the first integrator and a second input terminal connected to the second integrator, and
the comparator receives and compares the sensing output signal and the reference sensing output signal and generates an output value.

4. The display device of claim 3, further comprising:
a contact determining unit which determines that no touch is present when the output value is about zero (0).

5. The display device of claim 1, wherein
the sensing unit comprises:
a sensing switching element connected to the gate line and the sensing signal line;
a sensing element connected to the sensing switching element; and
a sensing capacitor connected to the sensing switching element, and
the reference sensing unit comprises:
a reference sensing switching element connected to the gate line and the reference sensing signal line;
a reference sensing element connected to the reference sensing switching element; and
a reference sensing capacitor connected to the reference sensing switching element.

6. The display device of claim 5, further comprising:
a sensing control voltage line connected to a control terminal of the sensing element and a control terminal of the reference sensing element; and
a common voltage line connected to the sensing capacitor and the reference capacitor and which transmits a common voltage.

7. The display device of claim 6, wherein the display panel further comprises:
an image data line crossing the gate line and which transmits an image data voltage; and
a pixel connected to the gate line and the image data line.

8. The display device of claim 7, wherein the display panel further comprises:
a lower panel;
an upper panel disposed opposite to the lower panel; and
a liquid crystal layer interposed between the lower panel and the upper panel, and
wherein the gate line, the common voltage line, the sensing unit and the reference sensing unit are disposed on the lower panel.

9. The display device of claim 8, wherein
the pixel comprises:
a pixel switching element connected to the gate line and the image data line;
a liquid crystal capacitor connected to the pixel switching element; and
a storage capacitor, and
the liquid crystal capacitor comprises:
a pixel electrode which receives the image data voltage; and
an opposing electrode which receives the common voltage.

10. The display device of claim 1, wherein
the display panel includes a display area where a plurality of pixels are disposed and a peripheral area surrounding at least a portion of the display area, and
the reference sensing unit and the reference sensing signal line are disposed in the peripheral area.

11. The display device of claim 10, wherein the sensing signal processor further comprises:
a first integrator which processes a sensing signal transmitted from the sensing unit to the sensing signal line to generate a sensing output signal; and
a second integrator which processes a reference sensing signal transmitted from the reference sensing unit to the reference sensing signal line to generate a reference sensing output signal.

12. The display device of claim 11, wherein
the comparator includes a first input terminal connected to the first integrator and a second input terminal connected to the second integrator, and
the comparator compares the inputted sensing output signal and the reference sensing output signal to generate an output value.

13. The display device of claim 12, further comprising:
a contact determining unit which determines that no touch is present when the output value is about zero (0).

14. A driving method of a display device including a gate line, a sensing signal line crossing the gate line, a reference sensing signal line crossing the gate line, a sensing unit connected to the gate line and the sensing signal line, and a reference sensing unit connected to the gate line and the reference sensing signal line, the method comprising:
applying a gate-on voltage to the gate line;
applying a reference voltage to the sensing unit and the reference sensing unit;
applying a gate-off voltage to the gate line;
transmitting a sensing signal from the sensing unit to the sensing signal line and transmitting a reference sensing signal from the reference sensing unit to the reference sensing signal line;
generating a sensing output signal by processing the sensing signal and generating a reference sensing output signal by processing the reference sensing signal; and
comparing the sensing output signal with the reference sensing output signal.

15. The method of claim 14, wherein
the sensing unit senses light by a touch on the display device, and
the reference sensing unit is blocked from the light by the touch.

16. The method of claim 15, wherein the generating the sensing output signal by processing the sensing signal and the generating the reference sensing output signal by processing the reference sensing signal comprises temporally integrating the sensing signal and temporally integrating the reference sensing signal, respectively.

17. The method of claim 16, further comprising:
generating an output value after the comparing the sensing output signal with the reference sensing output signal.

18. The method of claim 17, further comprising:
determining that no touch is present when the output value is about zero (0).

19. The method of claim 14, wherein
the sensing unit comprises:
a sensing switching element connected to the gate line and the sensing signal line;
a sensing element connected to the sensing switching element; and
a sensing capacitor e connected to the sensing switching element, and
the reference sensing unit comprises:
a reference sensing switching element connected to the gate line and the reference sensing signal line;
a reference sensing element connected to the reference sensing switching element; and
a reference sensing capacitor connected to the reference sensing switching element.

20. The method of claim 19, wherein
the applying the reference voltage to the sensing unit and the reference sensing unit comprise applying the reference voltage to the sensing capacitor of the sensing unit and the reference sensing capacitor of the reference sensing unit.

21. The method of claim 20, wherein
the sensing signal line and the reference sensing signal line transmit the reference voltage.
